(19) United States
(12) Patent Application Publication
(10) Pub. No.: US 2014/0139650 A1
(43) Pub. Date: May 22, 2014

(54) IMAGE PROCESSING APPARATUS AND IMAGE PROCESSING METHOD

(71) Applicant: KABUSHIKI KAISHA TOSHIBA, Tokyo (JP)

(72) Inventors: Tamotsu Hasegawa, Tokyo (JP); Takashi Kumagai, Kawasaki-shi (JP); Nobuyuki Ikeda, Fuchu-shi (JP)

(73) Assignee: KABUSHIKI KAISHA TOSHIBA, Tokyo (JP)

(21) Appl. No.: 14/165,398

(22) Filed: Jan. 27, 2014

Related U.S. Application Data
(63) Continuation of application No. 13/300,254, filed on Nov. 18, 2011.

(30) Foreign Application Priority Data
Dec. 21, 2010 (JP) 2010-284581

(51) Int. Cl. H04N 13/00

(52) U.S. Cl. CPC H04N 13/0022
USPC 348/51

(57) ABSTRACT

According to one embodiment, an image processing apparatus including a background image generator which generates a background image, a receiver which receives additional information, a depth memory which stores in advance a depth for each of types of the additional information, a depth decide module which determines a type of the additional information received by the receiver, and reads a depth which is associated with the determined type from the depth memory, a three-dimensional image generator which generates an object image based on the additional information, and generates a three-dimensional image based on the object image and the depth which is read by the depth decide module, an image composite module which generates a video signal by displaying the background image and displaying the three-dimensional image in front of the displayed background image, and an output module which outputs the video signal generated by the image composite module.

### CROSS-REFERENCE TO RELATED APPLICATIONS

This application is a continuation of U.S. application Ser. No. 13/300,254, filed Nov. 18, 2011, which is based upon and claims the benefit of priority from prior Japanese Patent Application No. 2010-284581, filed Dec. 21, 2010, the entire contents of both of which are incorporated herein by reference.

### FIELD

Embodiments described herein relate generally to an image processing apparatus and an image processing method.

### BACKGROUND

In recent years, image processing apparatuses (three-dimensional image display apparatuses) have been put into practical use which can cause the user to cognize a two-dimensional image as an image with solidity. The three-dimensional image display apparatuses display a left-eye image which can be cognized with the left eye and a right-eye image which can be cognized with the right eye on a display module. The image processing apparatuses can cause the user to recognize the image as a three-dimensional image, by causing the user's left eye to cognize the left-eye image and causing the user's right eye to cognize the right-eye image.

When an image including characters and the like is to be viewed by the user with solidity, there are cases where the characters are blurred. Therefore, when a picture is generated to cause the user to view an electronic program guide (EPG) or program information display with solidity, there is the problem that the characters are blurred and the user cannot recognize the character information.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view shown for explaining a three-dimensional display apparatus according to an embodiment.

FIG. 2 is an exemplary view shown for explaining an image processing apparatus according to an embodiment.

FIG. 3 is an exemplary view shown for explaining the image processing apparatus according to the embodiment.

FIG. 4 is an exemplary view shown for explaining the image processing apparatus according to the embodiment.

FIG. 5 is an exemplary view shown for explaining the image processing apparatus according to the embodiment.

FIG. 6 is an exemplary view shown for explaining the image processing apparatus according to the embodiment.

FIG. 7 is an exemplary view shown for explaining the image processing apparatus according to the embodiment.

FIG. 8 is an exemplary view shown for explaining the image processing apparatus according to the embodiment.

FIG. 9 is an exemplary view shown for explaining the image processing apparatus according to the embodiment.

FIG. 10 is an exemplary view shown for explaining the image processing apparatus according to the embodiment.

FIG. 11 is an exemplary view shown for explaining the image processing apparatus according to the embodiment.

### DETAILED DESCRIPTION

Various embodiments will be described hereinafter with reference to the accompanying drawings. In general, according to one embodiment, an image processing apparatus comprises: a background image generator which generates a background image; a receiver which receives additional information; a depth memory which stores in advance a depth for each of types of the additional information; a depth decide module which determines a type of the additional information received by the receiver, and reads a depth which is associated with the determined type from the depth memory; a three-dimensional image generator which generates an object image based on the additional information, and generates a three-dimensional image based on the object image and the depth which is read by the depth decide module; an image composite module which generates a video signal by displaying the background image and displaying the three-dimensional image in front of the displayed background image; and an output module which outputs the video signal generated by the image composite module.

An image processing apparatus and an image processing method according to an embodiment will be explained hereinafter with reference to drawings.

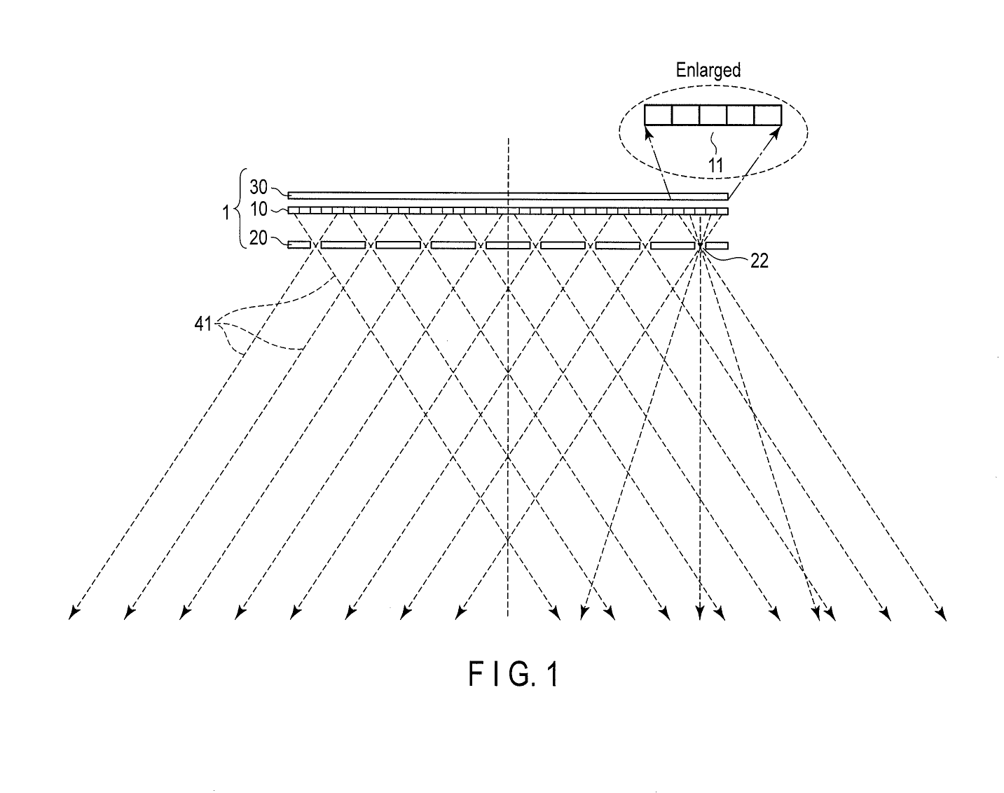

FIG. 1 is an exemplary view shown for explaining a three-dimensional display apparatus 1 according to the embodiment.

First, the principle of three-dimensional image display will be explained hereinafter. FIG. 1 is a diagram illustrating a cross section of a part of the three-dimensional display apparatus.

The three-dimensional display apparatus 1 comprises a display unit 10, a mask 20, and a backlight 30. The display unit 10 includes a number of pixels 10 which are arranged in rows and columns. The mask 20 includes a number of window parts 22. The mask 20 is disposed apart from the display unit 10 by a predetermined distance. The window parts 22 are provided in positions corresponding to the pixels 11.

The mask 20 includes optical openings which transmit light. The mask 20 has a function of controlling light beams emitted from the pixels 11. The mask 20 is also referred to as a parallax barrier or a light beam control element.

The mask 20 is formed of, for example, a transparent board in which a light-shield pattern is formed by a number of openings which correspond to the window parts 22. The mask 20 is formed of, for example, a light-shielding board in which a number of through holes that correspond to the window parts 22 are formed.

The mask 20 may be formed of a fly-eye lens which is formed by arranging a number of minute lenses in a two-dimensional manner. The mask 20 may be formed of, for example, a lenticular lens which is formed by periodically arranging a plurality of optical openings, which extend in a straight line in a vertical direction, in a horizontal direction. The arrangement, size, and shape of the mask 20 may be changed as desired according to the arrangement of the pixels 11 of the display unit 10.

The backlight 30 is a light source which emits light. The backlight 30 includes a light source such as a cold cathode-ray tube and an LED device. The light emitted from the backlight 30 is transmitted through the pixels 11 of the display unit 10, and passes through the mask 20. Each pixel 11 of the display unit 10 polarizes the transmitted light. Thereby, each of the pixels 11 can display various colors.

In addition, the mask 20 transmits light emitted from the pixels 11 which exist in a straight line with the respective window parts 22. Consequently, the three-dimensional display apparatus 1 can emit light beams of various colors in directions of light beams 41 illustrated in FIG. 1.

As described above, although the present embodiment shows an example of three-dimensional display by an integral method, the three-dimensional display apparatus 1 is not limited to the above structure. The three-dimensional display method of the three-dimensional display apparatus 1 may be other methods such as a naked-eye method, a shutter-spectacle method, and a polarizing spectacle method.

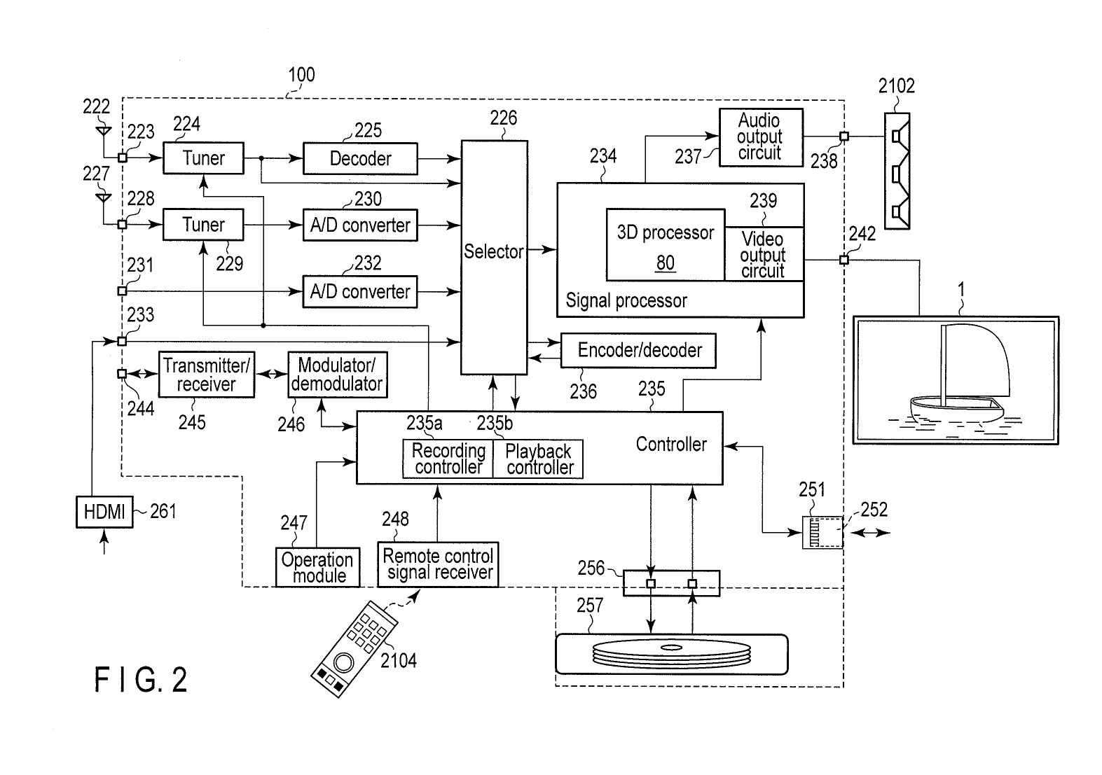

FIG. 2 is an exemplary view shown for explaining an image processing apparatus 100 according to the embodiment. The image processing apparatus 100 includes an input terminal 223, a tuner 224, a decoder 225, and a selector 226.

The input terminal 223 is an input terminal to which a digital broadcasting signal received by an antenna 222 is input. The antenna 222 receives, for example, a ground-wave digital broadcasting signal, a BS (broadcasting satellite) digital broadcasting signal, and/or a 110° CS (communication satellite) digital broadcasting signal. Specifically, the input terminal 223 receives content such as a program supplied by the broadcasting signal.

The input terminal 223 supplies the received digital broadcasting signal to the tuner 224. The tuner 224 is a tuner for digital broadcasting signals. The tuner 224 performs tuning (selection) of the digital broadcasting signal supplied from the antenna 222. The tuner 224 transmits the tuned digital broadcasting signal to the decoder 225.

The decoder 225 demodulates the digital broadcasting signal supplied from the tuner 224. The decoder 225 inputs the demodulated digital broadcasting signal (content) to the selector 226. Specifically, the input terminal 223, the tuner 224, and the decoder 225 function as receiving means for receiving content. When the signal received by the input terminal 223 is not encoded, the image processing apparatus 100 may have a structure in which the tuner 224 inputs the received signal to the selector 226.

The image processing apparatus 100 also includes an input terminal 228, a tuner 229, and an A/D converter 230.

The input terminal 228 is an input terminal to which, for example, an analog broadcasting signal that is received by an antenna 227 is input. The antenna 227 receives analog broadcasting signals. Specifically, the input terminal 228 receives content such as a program supplied by an analog broadcasting signal.

The input terminal 228 supplies the received analog broadcasting signal to the tuner 229. The tuner 229 is a tuner for analog broadcasting signals. The tuner 229 performs tuning (selection) of the analog broadcasting signal supplied from the antenna 227. The tuner 229 transmits the tuned analog broadcasting signal to the A/D converter 230.

The A/D converter 230 converts the analog broadcasting signal supplied from the tuner 229 into a digital signal. The A/D converter 230 inputs the converted digital broadcasting signal (content) to the selector 226.

The image processing apparatus 100 also includes an input terminal 231, and an A/D converter 232. The input terminal 231 is an input terminal for receiving analog signals. The input terminal 231 is connected to an apparatus which outputs an analog video signal and audio signal. The input terminal 231 supplies the received analog signal to the A/D converter 232.

The A/D converter 232 converts the analog signal supplied from the input terminal 231 into a digital signal. The A/D converter 232 inputs the converted digital signal to the selector 226.

The image processing apparatus 100 also includes an input terminal 233. The input terminal 233 is an input terminal for receiving digital signals, and includes, for example, an HDMI (High Definition Multimedia Interface). The input terminal 233 is connected to an apparatus which outputs a digital video signal and audio signal. The input terminal 233 is connected to, for example, an apparatus (HDMI apparatus) 261 which can transmit and receive data in the HDMI format. The input terminal 233 receives a digital signal inputted from the HDMI apparatus. The input terminal 233 supplies the received digital signal to the selector 226.

The selector 226 selects one of the digital broadcasting signal supplied from the decoder 225, the digital signal supplied from the A/D converter 230, the digital signal supplied from the A/D converter 232, and the digital signal supplied from the input terminal 233, and supplies the selected signal to a signal processor 234.

The image processing apparatus 100 also includes the signal processor 234, a control module 235, an encoder/decoder 236, an audio output circuit 237, an output terminal 238, a video output circuit 239, and an output terminal 242.

The signal processor 234 divides the input digital signal into an audio signal, a video signal, and other data (such as metadata). The signal processor 234 subjects the divided audio signal and the video signal to various signal processing.

For example, the signal processor 234 subjects the audio signal to audio decoding, sound quality control, and mixing, if necessary. In addition, the signal processor 234 subjects the video signal to color and brightness separation processing, color control processing, and image quality control processing. The signal processor 234 also subjects the video signal to control of tone, brightness, sharpness, contrast, and other image quality control processing based on, for example, control by the control module 235.

The signal processor 234 supplies the audio signal to the audio output circuit 237. The signal processor 234 also supplies the video signal to the video output circuit 239. The signal processor 234 also supplies other data to the control module 235.

The audio output circuit 237 converts the audio signal received from the signal processor 234 into an audio signal of a format which can be played back by speakers 2102. The audio output circuit 237 outputs the audio signal to the output terminal 238. The output terminal 238 outputs the supplied audio signal to the outside of the apparatus. Thereby, the speakers 2102 which are connected to the output terminal 238 play back sound based on the supplied audio signal.

The video output circuit 239 converts the video signal received from the signal processor 234 into a video signal of a format which can be played back by the three-dimensional display apparatus 1. Specifically, the video output circuit 239 decodes (plays back) the video signal received from the signal processor 234 into a video signal of a format which can be played back by the three-dimensional display apparatus 1. The video output circuit 239 outputs the video signal to the output terminal 242. The three-dimensional display apparatus 1 which is connected to the output terminal 242 displays an image based on the supplied video signal.

The image processing apparatus 100 may have a structure of including the three-dimensional display apparatus 1 inside the apparatus 100, instead of the output terminal 242. The image processing apparatus 100 may have a structure of including the speakers 2102 inside the apparatus 100, instead of the output terminal 238.

The control module 235 functions as control means for controlling operations of the modules in the image processing apparatus 100. The control module 235 includes a CPU, a ROM, a RAM, and an EEPROM and the like. The control module 235 performs various processing based on operation signals supplied from an operation module 247 or a remote control signal receiver 248.

The CPU includes an operation element which performs various operations. The CPU realizes various functions by executing programs stored in the ROM or the EEPROM.

The ROM stores a program to control the image processing apparatus 100, and a program to realize various functions. The CPU starts a program stored in the ROM, based on an operation signal supplied from the operation module 247 or the remote control signal receiver 248. Thereby, the control module 235 controls operations of the modules.

The RAM functions as a work memory of the CPU. Specifically, the RAM stores operation results of the CPU, and data read by the CPU.

The EEPROM is a nonvolatile memory which stores various setting information items and programs.

The control module 235 includes a recording controller 235a and a playback controller 235b which are realized by the above CPU, the ROM, the RAM, and the EEPROM. The recording controller 235a controls the modules to record the signal selected by the selector 226. The playback controller 235a controls the modules to play back content recorded in the image processing apparatus 100, or content recorded in an apparatus that is connected to the image processing apparatus 100.

The control module 235 generates information (GUI item) to display an object such as GUI (graphic user interface) on the screen. The control module 235 reads a GUI item which is recorded in advance in a storage device such as the ROM and the EEPROM. In addition, the control module 235 generates a GUI item to display subtitles, the time, program information, a menu picture, or other information, based on information supplied from the selector 226. The control module 235 supplies the generated GUI items to the signal processor 234. The signal processor 234 draws various objects in the video signal, based on the GUI items supplied from the control module 235.

The image processing apparatus 100 also includes a connection terminal 244, a transmitter/receiver 245, a modulator/demodulator 246, the operation module 247, the remote control signal receiver 248, a connector 251, and a terminal 256.

The connection terminal 244 includes a connection terminal, such as a LAN port, to connect to a network. The image processing apparatus 100 may include a wireless LAN module instead of the connection terminal 244.

The transmitter/receiver 245 performs data transmission and reception with a server on a network or the like through the connection terminal 244. The modulator/demodulator 246 modulates and demodulates data which is transmitted/received by the transmitter/receiver 245. Thereby, the image processing apparatus 100 can obtain and play back content data of moving pictures on a network.

The operation module 247 is an operation input module which includes operation keys, a keyboard, a mouse, a touch pad, or other input devices that can generate an operation signal in response to an operation input. For example, the operation module 247 generates an operation signal in response to an operation input. The operation module 247 supplies the generated operation signal to the control module 235.

The touch pad includes an electrostatic sensor, a thermosensor, or a device which generates positional information based on another method. When the image processing apparatus 100 includes the three-dimensional display apparatus 1 or another display apparatus, the operation module 247 may have a structure of including a touch panel which is formed as one unitary piece with the display apparatus.

The remote control signal receiver 248 includes a sensor which receives, for example, an operation signal from a remote controller 2104. The remote control signal receiver 248 supplies the received operation signal to the control module 235. The remote controller 2104 generates an operation signal based on an operation input by the user. The remote controller 2104 transmits the generated operation signal to the remote control signal receiver 248 by infrared communication. The remote control signal receiver 248 and the remote controller 2104 may have a structure of performing transmission and reception of operation signals by another wireless communication such as optical communication and radio wave communication.

The connector 252 includes a card connector to which various memory cards can be connected. The connector 252 is an interface configured to perform communication with, for example, a memory card which stores moving picture content. The connector 252 reads moving picture content data from the connected memory card, and supplies the data to the control module 235.

The terminal 256 is a terminal to which a storage device such as a hard disk drive (HDD) 257 can be connected. The terminal 256 reads moving picture content data from the HDD 257 which stores moving picture content, and supplies the data to the control module 235.

The storage device which is connected to the terminal 256 may be a storage device such as a solid state drive (SSD) and a semiconductor memory. The image processing apparatus 100 can read and play back content which is stored in the storage device. The image processing apparatus 100 can also store content, which is supplied by a broadcasting signal or a network, in the storage device.

The image processing apparatus 100 may further include a USB connector configured to perform communication with an USB device. The USB connector supplies a signal which is supplied from the connected USB device to the control module 235.

For example, when the USB device is an operation input device such as a keyboard, the USB connector receives an operation signal from the USB device. The USB connector supplies the received operation signal to the control module 235. In this case, the control module 235 performs various processing based on the operation signal supplied from the USB connector.

In addition, for example, when the USB device is a storage device which stores moving picture content data, the USB connector can obtain the content from the USB device. The USB connector supplies the obtained content from the control module 235.

Besides, the image processing apparatus 100 may further include a disk drive. The disk drive includes a drive to which a compact disk (CD), a digital versatile disk (DVD), a blu-ray disk (BD), or another optical disk which can store moving picture content data can be attached. The disk drive reads content from the attached optical disk, and supplies the read content to the control module 235.

The image processing apparatus further includes a power source module (not shown). The power source module supplies electric power to the modules of the image processing apparatus 100. The power source module converts electric power, which is supplied through an AC adaptor or the like, and supplies the converted electric power to the modules. The power source module may include a battery. In this case, the power source module charges the battery with electric power supplied through the AC adaptor or the like. The power source module supplies the electric power of the battery to the modules of the image processing apparatus 100.

The signal processor 234 includes a three-dimensional processor 80. The three-dimensional processor 80 performs three-dimensional display based on content that includes a right-eye image and a left-eye image, between which parallax exists. The three-dimensional processor 80 processes a video signal such that the user recognizes a three-dimensional image based on a right-eye image and a left-eye image.

In addition, the three-dimensional processor 80 performs three-dimensional display of objects such as a menu picture, an EPG picture, program information, and alert, based on GUI items supplied from the control module 235.

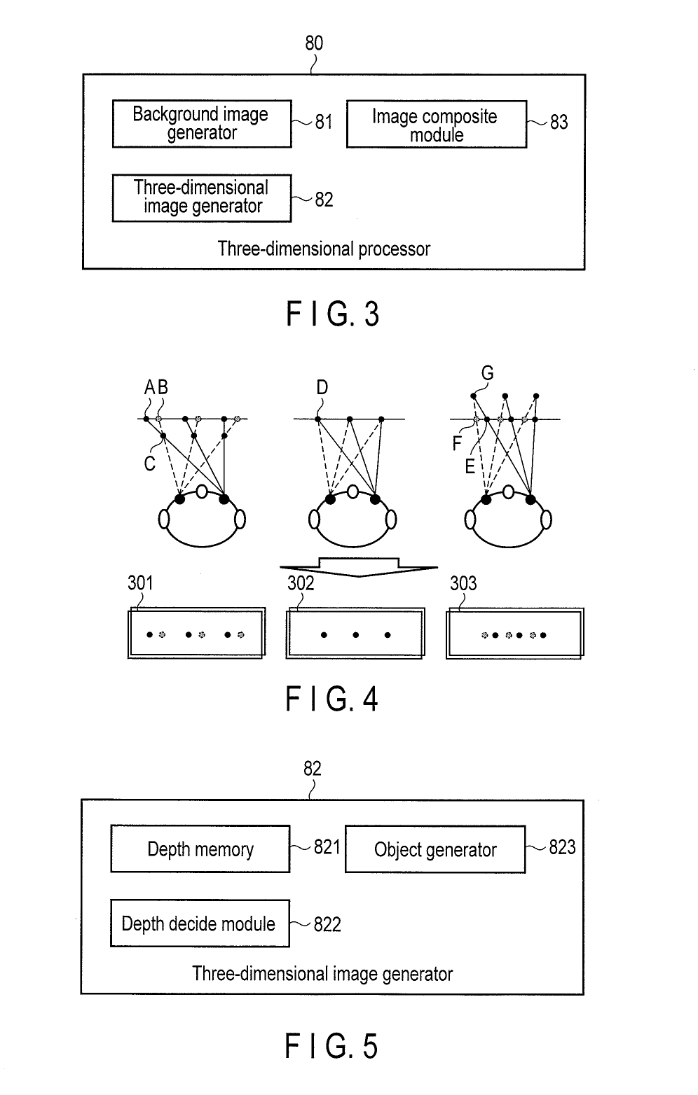

FIG. 3 is an exemplary view shown for explaining an example of a structure of the three-dimensional processor 80.

As illustrated in FIG. 3, the three-dimensional processor 80 includes a background image generator 81, a three-dimensional image generator 82, and an image composite module 83.

The background image generator 81 generates a background image which is displayed on a display screen. The background image generator 81 generates, for example, an ordinary broadcasting display picture.

The three-dimensional image generator 82 generates a three-dimensional image such that the user recognizes various objects as a three-dimensional image. The three-dimensional image generator 82 generates a three-dimensional image to display objects such as a menu picture, an EPG picture, a broadcasting mail display picture, alert, program information, and other information, based on additional information. For example, the three-dimensional image generator 82 generates a right-eye image and a left-eye image as three-dimensional image to display objects such that the user can recognize the objects as a three-dimensional image.

The image composite module 83 combines the background image generated by the background image generator 81 with the three-dimensional image generated by the three-dimensional image generator 82. Specifically, the image composite module 83 displays the background image first, and displays the three-dimensional image in a layer which is higher (front layer in the display) than that of the background image.

For example, the image composite module 83 displays the background image, and displays the right-eye image and the left-eye image of the three-dimensional image in a layer which is higher than that of the background image. Thereby, the image composite module 83 generates a video signal which includes images of objects which have parallax. The method of three-dimensional display is not limited to the above method, but may be of any method.

The image composite module 83 outputs the generated video signal to the video output circuit 239. The video output circuit 239 outputs the video signal received from the image composite module 83 to the three-dimensional display apparatus 1. Thereby, the three-dimensional display apparatus 1 displays a picture which includes object images in a state in which the user can recognize the object images as three-dimensional image.

FIG. 4 is an exemplary view shown for explaining an example of a picture which is generated by the image processing apparatus 100.

In the case of causing the user to recognize that point C illustrated in FIG. 4 project, the image processing apparatus 100 generates a video signal such that point A and point B are projected on a standard plane which is set to a certain plane (for example, a projection plane). In this case, the image processing apparatus 100 generates the video signal in a state the point A can be viewed by the user's right eye. In addition, the image processing apparatus 100 generates the video signal in a state where the point B can be viewed by the user's left eye.

However, when such a video signal is displayed by the three-dimensional display apparatus 1, there are cases where the point A and the point B are viewed by the user's both eyes, as illustrated in a picture 301. In such cases, point C may be viewed in a blurred state for the user.

In addition, when the user is caused to recognize that point D exist on a standard plane, the image processing apparatus 100 displays the point D in the same respective positions of both a picture which can be viewed by the user's right eye and a picture which can be viewed by the user's left eye. In such cases, the user can view the point D which are not blurred as illustrated in a picture 302.

Besides, when the user is caused to recognize that point G illustrated in FIG. 4 exist on the rear side of the screen, the image processing apparatus 100 generates a video signal such that point E and point F are projected on the standard plane. In such cases, the image processing apparatus 100 generates the video signal such that the point E can be viewed by the user's right eye. In addition, the image processing apparatus generates the video signal such that the point F can be viewed by the user's left eye.

Also in this case, when the video signal as described above is displayed by the three-dimensional display apparatus 1, there are cases where the point E and the point F are viewed by the user's both eyes. In such cases, the point G may be viewed in a blurred state for the user. Blurring is a larger problem for GUI items which include display of characters than for other GUI items.

A difference in the display position between a point in the right-eye image and a point in the left-eye image increases, as the three-dimensional image is more distant from the standard plane. The image which is viewed by the user is blurred more easily, as the three-dimensional image is positioned more distant from the standard plane. Therefore, the image processing apparatus 100 controls a depth at which the three-dimensional image is displayed, according to a property of the GUI item.

FIG. 5 is an exemplary view shown for explaining the three-dimensional image generator 82. The three-dimensional image generator 82 includes a depth memory 821, a depth decide module 822, and an object generator 823.

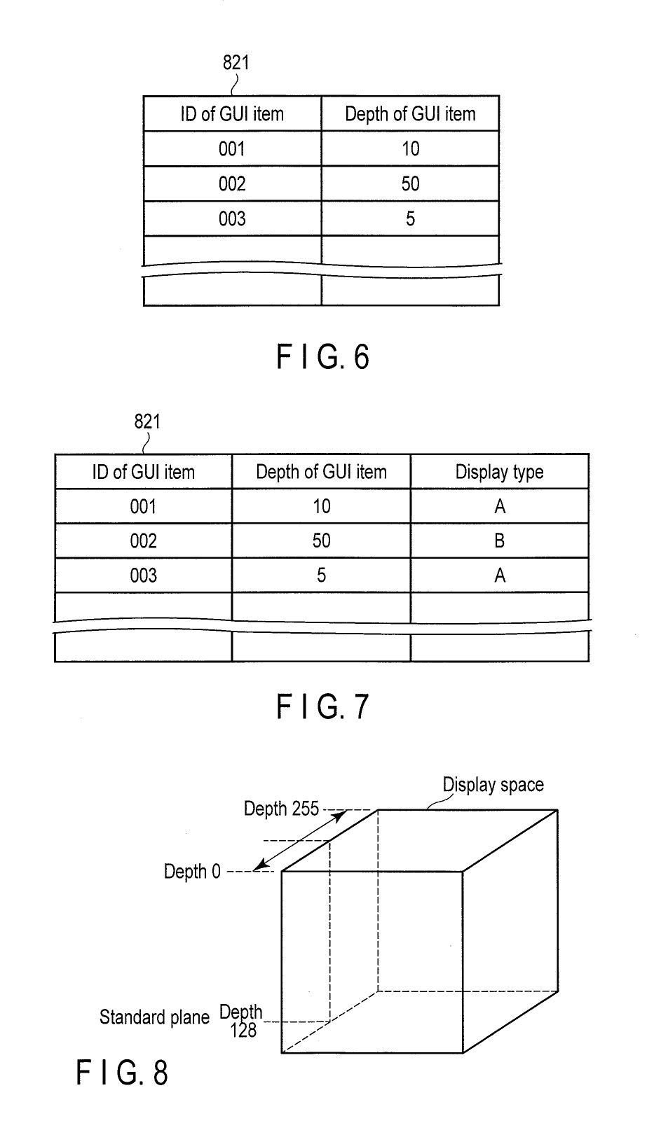

The depth memory 821 is a table which stores a depth for each GUI item. FIG. 6 is a diagram illustrating a structure of the depth memory 821. As illustrated in FIG. 6, the depth memory 821 is a table which stores an ID (identification information) that indicates a GUI item in association with a depth of the GUI item. The image processing apparatus 100 can set the value of the depth stored by the depth memory 821, based on an operation inputted by the user. In addition, the image processing apparatus 100 may have a structure of performing authentication using a preset password in the case of using the value of the depth, and allowing setting of the depth when the inputted password agrees with the preset password.

The depth memory 821 may be configured as illustrated in FIG. 7. FIG. 7 is a diagram illustrating another structure of the depth memory 821. The depth memory 821 illustrated in FIG. 7 stores ID (identification information) which indicates an GUI item in association with a depth of the GUI item and a display type thereof. The display type is set to indicate, for example, whether the GUI item includes display of characters or not. Thereby, when the GUI item includes display of characters, it is possible to set the depth of the part of the characters to a value which is closer to the standard plane than the depth stored in the table is. In the case of using the depth memory 821 having the above structure, the control module 235 inputs a GUI item (additional information) which includes information indicating the display type to the signal processor 234.

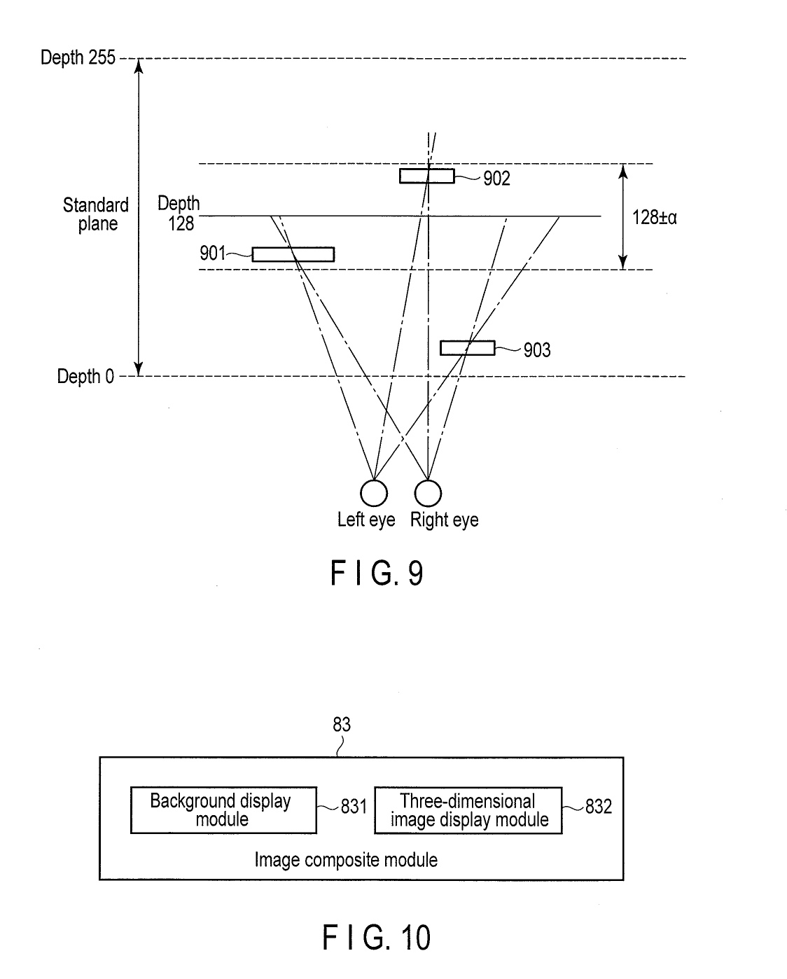

FIG. 8 and FIG. 9 are exemplary views shown for explaining depths. In a display space in which three-dimensional display can be performed by the three-dimensional display apparatus 1, suppose that the front surface (viewer's side) is set to a depth of 0, the rear surface is set to a depth of 255, and the depth of the standard plane (projection plane) is set to 128. In this case, when the GUI item is a GUI item which includes display of characters, the depth memory 821 changes the depth of the GUI item from 128 within a preset range (for example, 128±α).

FIG. 9 is a top view of the display space illustrated in FIG. 8. GUI items 901 and 902 illustrated in FIG. 9 include display of characters. Therefore, in the depth memory 821, depths which fall within a predetermined range from the depth of the standard plane are set for the respective GUI items 901 and 902. Therefore, the GUI items 901 and 902 illustrated in FIG. 9 are displayed with depths which are close to the depth of the standard plane. A GUI item 903 illustrated in FIG. 9 is a GUI item which does not include display of characters. Therefore, the GUI item 903 is displayed with a depth of a position which is distant from the standard plane and has a larger 3D effect than those of the GUI items 901 and 902.

The depth decide module 822 illustrated in FIG. 5 reads a depth from the depth memory 821, based on the ID or the display type of the GUI item (additional information) supplied from the control module 235. Specifically, the depth decide module 822 determines a type (ID or the display type) of the GUI item supplied from the control module 235, and reads a depth which is associated with the determined type from the depth memory 821. The depth decide module 822 supplies the read depth to the object generator 823.

The object generator 823 illustrated in FIG. 5 generates an image (object image) which indicates an object such as a menu picture, an EPG picture, a broadcasting mail display picture, alert, program information, and other information, based on a GUI item (additional information) supplied from the control module 235.

In addition, the object generator 823 generates a three-dimensional image, based on the depth outputted from the depth decide module 822 and the object image. The three-dimensional image includes a right-eye image which is viewed by the user's right eye and a left-eye image which is viewed by the user's left eye.

Based on the depth, the object generator 823 determines an area in which an object image in the right-eye image is displayed, and an area in which an object image in the left-eye image is displayed. The object generator 823 displays the object images in the respective determined areas, and thereby generates a three-dimensional image. The object image which is displayed in the right-eye image and the object image which is displayed in the left-eye image have parallax. The object generator 823 outputs the generated three-dimensional image to the image composite module 83.

FIG. 10 is an exemplary view shown for explaining the image composite module 83. The image composite module 83 includes a background image display module 831, and a three-dimensional image display module 832.

The image composite module 83 combines the background image which is generated by the background image generator 81 with the three-dimensional image which is generated by the three-dimensional image generator 82. The background image display module 831 displays the background image generated by the background image generator 81. In this case, the background image display module 831 displays the background image with a preset standard depth (for example, the depth of the standard plane). The image which is displayed with the standard depth is displayed in a state there is no parallax between the right-eye image and the left-eye image. Specifically, the image is displayed to cause the user to recognize the image as a two-dimensional image, not a three-dimensional image. In addition, the three-dimensional image display module 832 displays the three-dimensional image, which is generated by the three-dimensional image generator 82, in a layer which is higher (front layer in the display) than that of the background image.

Thereby, the image composite module 83 generates a video signal which includes object images that have parallax. The image composite module 83 outputs the video signal which is received from the image composite module 83 to the three-dimensional display apparatus 1. Thereby, the three-dimensional display apparatus 1 displays a picture which includes object images in a state where the user can recognize the object images as a three-dimensional image.

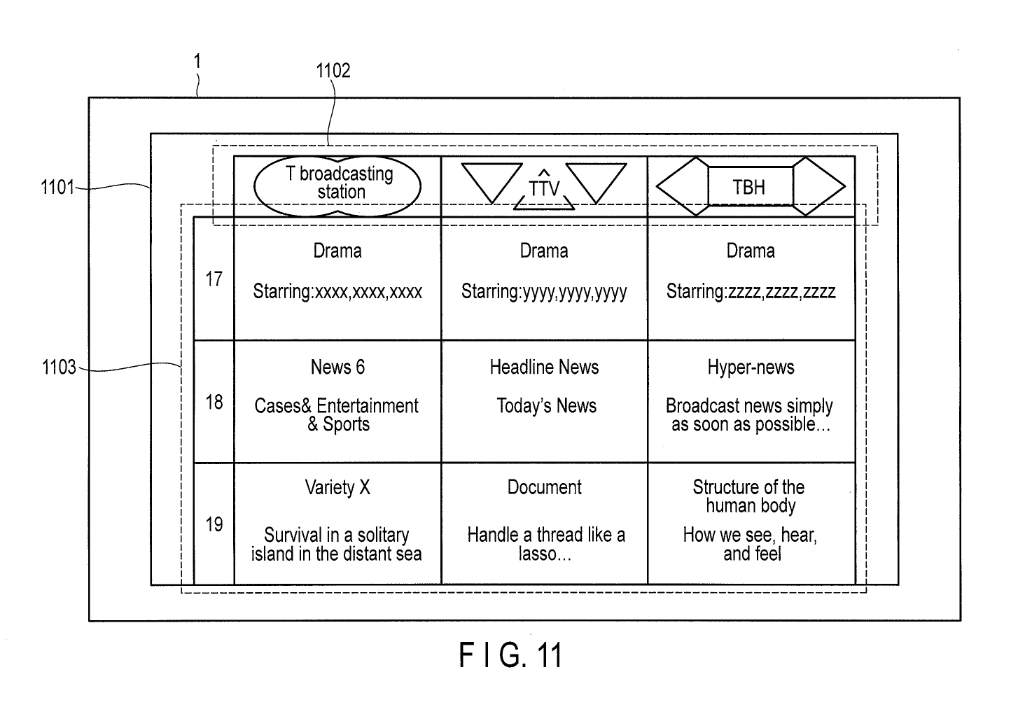

FIG. 11 is an exemplary view shown for explaining an example of a picture which is generated by the image processing apparatus 100 and displayed by the three-dimensional display apparatus 1. In the present embodiment, an example in which an EPG picture is displayed is shown.

A window 1101 illustrated in FIG. 11 is a window to display an EPG picture. The window 1101 includes a display area for a channel banner 1102, and a display area for program information 1103.

The channel banner 1102 does not include display of minute characters, and thus the depth memory 821 stores a depth, which is distant from the standard plane and has a high 3D effect, for the channel banner 1102. Therefore, for example, the channel banner 1102 is displayed with a depth like that of the GUI item 903 illustrated in FIG. 9. The image processing apparatus 100 may have a structure of performing display of the channel banner 1102, in conformity to a depth which is indicated by the GUI item (additional information) received from the control module 235.

The program information 1103 includes display of minute characters, and thus the depth memory 821 stores a depth, which is close to the standard plane, for the program information 1103. Therefore, for example, the program information 1103 is displayed with a depth like that of the GUI item 901 or 902 illustrated in FIG. 9.

The image processing apparatus 100 may have a structure of displaying a GUI item with the depth of the standard plane, when the GUI item includes display of minute characters.

As described above, when an object to be displayed as a three-dimensional image includes characters or the like, the image processing apparatus 100 performs three-dimensional display of the object with a depth which is stored in advance in the depth memory 821. Thereby, the image processing apparatus 100 prevents characters from being blurred and becoming difficult to see due to three-dimensional display. As a result, it is possible to provide an image processing apparatus and an image processing method, which can more effectively display a three-dimensional image.

There are image processing apparatuses which can set the intensity of the 3D effect. When the above depth memory 821 is applied to such image processing apparatuses, the depth memory 821 may have a structure of storing a depth for each intensity of the 3D effect. In addition, the depth memory 821 may have a structure of simply adding a depth to the depth in accordance with the intensity of the 3D effect, or calculating a depth in each intensity by linear operation.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
a background image generator configured to generate a background image;
a receiver configured to receive additional information, the additional information having a plurality of types;
a depth memory configured to store, in advance, a depth associated with each of the types of the additional information;
a depth decide module configured to determine a type of the additional information received by the receiver, and to read a depth associated with the determined type from the depth memory;
a three-dimensional image generator configured to generate an object image based on the additional information, and to generate a three-dimensional image based on the object image and the depth read by the depth decide module;
an image composite module configured to generate a video signal by displaying the background image and displaying the three-dimensional image; and
an output module configured to output the video signal generated by the image composite module,
wherein the three-dimensional image generator is further configured to generate the three-dimensional image by a depth which is set within a range based on the depth of a standard plane, when the object image including a character display is generated, and wherein the depth which is set within the range is close to the depth of the standard plane and the standard plane is a projection plane.

2. The image processing apparatus of claim 1, wherein the depth decide module is further configured to:
determine whether the additional information received by the receiver includes a character display or not; and
when the additional information includes character display, to read the depth associated with the determined type from the depth memory.

3. The image processing apparatus of claim 1, wherein the depth decide module is further configured to:
determine whether the additional information received by the receiver includes a character display or not; and
when the additional information does not include character display, to read a depth indicated by the additional information from the additional information.

4. An image processing method executed by an image processing apparatus, the method comprising:
generating a background image;
receiving additional information having a plurality of types;
storing, in advance, a depth for each of the types of the additional information;
determining a type of the received additional information;
reading a depth associated with the determined type from the stored depths;
generating an object image based on the additional information;
generating a three-dimensional image by a depth which is set within a first range based on the depth of a standard plane, when the object image including a character display is generated, wherein the depth which is set within the range is close to the depth of the standard plane and the standard plane is a projection plane;
generating a video signal by displaying the background image and displaying the three-dimensional image; and
outputting the generated video signal.

5. An image processing apparatus comprising:
a background image generator configured to generate a background image;
a receiver configured to receive additional information, the additional information having a plurality of types;
a depth memory configured to store, in advance, a depth associated with each of the types of the additional information;
a depth decide module configured to determine a type of the additional information received by the receiver, and to read a depth associated with the determined type from the depth memory;
a three-dimensional image generator configured to generate an object image based on the additional information, and to generate a three-dimensional image based on the object image and the depth read by the depth decide module;
an image composite module configured to generate a video signal by displaying the background image and displaying the three-dimensional image; and
an output module configured to output the video signal generated by the image composite module,
wherein the three-dimensional image generator is further configured to generate the three-dimensional image by a depth which is set within a range based on the depth of a standard plane, when the object image including a character display is generated, and
wherein a depth of the character display part is closer to the depth of the standard plane than the depth stored in the depth memory.
